(19) United States
(12) Patent Application Publication
(10) Pub. No.: US 2023/0155667 A1
(43) Pub. Date: May 18, 2023

(54) SATELLITE COMMUNICATION EARTH STATION AND COMMUNICATION CONTROL METHOD

(71) Applicant: NIPPON TELEGRAPH AND TELEPHONE CORPORATION, Tokyo (JP)

(72) Inventors: Hiroki SHIBAYAMA, Musashino-shi, Tokyo (JP); Koichi HARADA, Musashino-shi, Tokyo (JP); Masaki SHIMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 17/919,575

(22) PCT Filed: Apr. 21, 2020
(86) PCT No.: PCT/JP2020/017241

§ 371 Date: Oct. 18, 2022

(51) Int. Cl. H04B 7/185; H04B 1/04

(52) U.S. Cl. CPC H04B 7/185; H04B 1/04

(57) ABSTRACT

A satellite communication earth station includes a detection unit that detects a longitude, a latitude, an altitude, an azimuth, and an inclination of the antenna, a drive unit that drives the antenna to adjust the azimuth angle, the elevation angle, and the polarization angle of the antenna to the communication satellite, a determination unit that determines whether the longitude, the latitude, the altitude, the azimuth, or the inclination detected by the detection unit or the azimuth angle, the elevation angle, or the polarization angle driven by the drive unit makes a change from an initial setting value to a predetermined threshold value or more, and a stop processing unit that stops transmission of the radio wave from the antenna when the determination unit determines that the change from the initial setting value to the predetermined threshold value or more is made.

### TECHNICAL FIELD

The present disclosure relates to a satellite communication earth station and a communication control method.

### BACKGROUND ART

An existing satellite communication earth station that performs wireless communication with a communication satellite includes a global navigation satellite system (GNSS) receiver, an azimuth sensor, and an acceleration sensor and detects a latitude, a longitude, and an altitude where the satellite communication earth station is located, an azimuth, and an inclination of a ground surface.

The GNSS includes a system that receives radio waves from satellites to measure the position, such as a global positioning system (GPS) and a quasi-zenith satellite system (QZSS).

Also, the satellite communication earth station holds in advance the position (the latitude, the longitude, and the altitude) of the communication satellite in a satellite position storage unit and calculates a direction directed from the satellite communication earth station to the communication satellite (satellite direction) in accordance with the latitude, the longitude, and the altitude of the communication satellite that is a communication counterpart and the latitude, the longitude, and the altitude of the satellite communication earth station, the azimuth, and the inclination of the ground surface when the satellite communication earth station starts communication.

Then, the satellite communication earth station calculates a rotation angle of an azimuth angle control motor of an antenna, a rotation angle of an elevation angle control motor, and a rotation angle of a polarization angle control motor such that the antenna is directed to the satellite and performs setting to direct the antenna to the communication satellite. This allows the satellite communication earth station to communicate with the communication satellite (see PTL 1, for example).

### CITATION LIST

### Patent Literature

PTL 1: JP 5425826 B

### SUMMARY OF THE INVENTION

### Technical Problem

Although the satellite communication earth station adjusts and fixes the direction of the antenna to the communication satellite before communication, the position of the satellite communication earth station may change during communication, or the rotation angle set by each control motor may be changed by force applied to the antenna. At this time, the antenna may be directed to a direction different from the communication satellite, and unfortunately, the satellite communication earth station may give radio wave interference for other satellites.

An object of the present disclosure is to provide a satellite communication earth station and a communication control method capable of preventing radio wave interference from being provided to other satellites when the direction of the antenna changes due to disturbance.

### Means for Solving the Problem

A satellite communication earth station according to an aspect of the present disclosure for adjusting an azimuth angle, an elevation angle, and a polarization angle of an antenna to a communication satellite and then transmitting and receiving a radio wave between the antenna and the communication satellite includes a detection unit that detects a longitude, a latitude, an altitude, an azimuth, and an inclination of the antenna, a drive unit that drives the antenna to adjust the azimuth angle, the elevation angle, and the polarization angle of the antenna to the communication satellite, a determination unit that determines whether the longitude, the latitude, the altitude, the azimuth, or the inclination detected by the detection unit or the azimuth angle, the elevation angle, or the polarization angle driven by the drive unit makes a change from an initial setting value to a predetermined threshold value or more, and a stop processing unit that stops transmission of the radio wave from the antenna when the determination unit determines that the change from the initial setting value to the predetermined threshold value or more is made.

Also, a communication control method according to an aspect of the present disclosure for controlling communication of a satellite communication earth station for adjusting an azimuth angle, an elevation angle, and a polarization angle of an antenna to a communication satellite and then transmitting and receiving a radio wave between the antenna and the communication satellite includes detecting a longitude, a latitude, an altitude, an azimuth and an inclination of the antenna, performing driving the antenna to adjust the azimuth angle, the elevation angle, and the polarization angle of the antenna to the communication satellite, determining whether the longitude, the latitude, the altitude, the azimuth, or the inclination detected or the azimuth angle, the elevation angle, or the polarization angle driven makes a change from an initial setting value to a predetermined threshold value or more, and stopping transmission of the radio wave from the antenna when it is determined that the change from the initial setting value to the predetermined threshold value or more is made.

### Effects of the Invention

The present disclosure allows for preventing radio wave interference from being given to other satellites when the direction of the antenna changes due to disturbance.

### BRIEF DESCRIPTION OF DRAWINGS

FIG. 1 is a diagram illustrating, as an example, an overview of a satellite communication system according to an embodiment.

FIG. 2 is a functional block diagram illustrating, as an example, an overview of functions that a satellite communication earth station has according to the embodiment.

FIG. 3 is a diagram illustrating, as an example, each value stored in a detection data storage unit.

FIG. 4 is a diagram illustrating, as an example, each value stored in a control value storage unit.

FIG. 5 is a flowchart illustrating an operation example of the satellite communication earth station according to the embodiment.

FIG. 6 is a diagram illustrating a hardware configuration example of the satellite communication earth station according to the embodiment.

### DESCRIPTION OF EMBODIMENTS

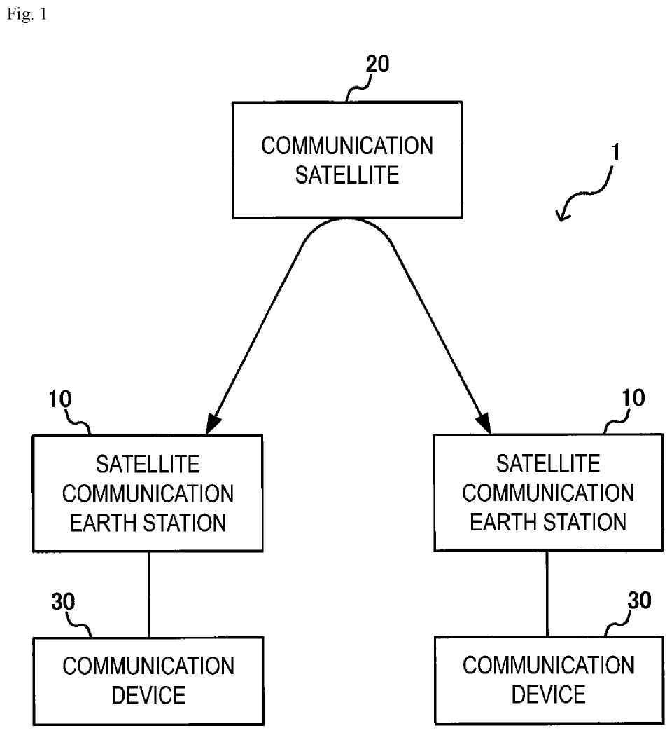

Hereinafter, an embodiment of a satellite communication system will be described using the drawings. FIG. 1 is a diagram illustrating, as an example, an overview of a satellite communication system 1 according to an embodiment. The satellite communication system 1 is, for example, a system in which a plurality of satellite communication earth stations 10 perform wireless communication via a communication satellite 20.

Also, communication devices 30 are connected to each satellite communication earth station 10. In other words, the satellite communication system 1 is a system that enables the plurality of communication devices 30 to perform communication via the satellite communication earth stations 10 and the communication satellite 20. In addition, the satellite communication earth stations 10 adjust azimuth angles, elevation angles, and polarization angles of antennas that the satellite communication earth stations 10 themselves include in accordance with the communication satellite 20 and then transmit and receive radio waves to and from the communication satellite 20.

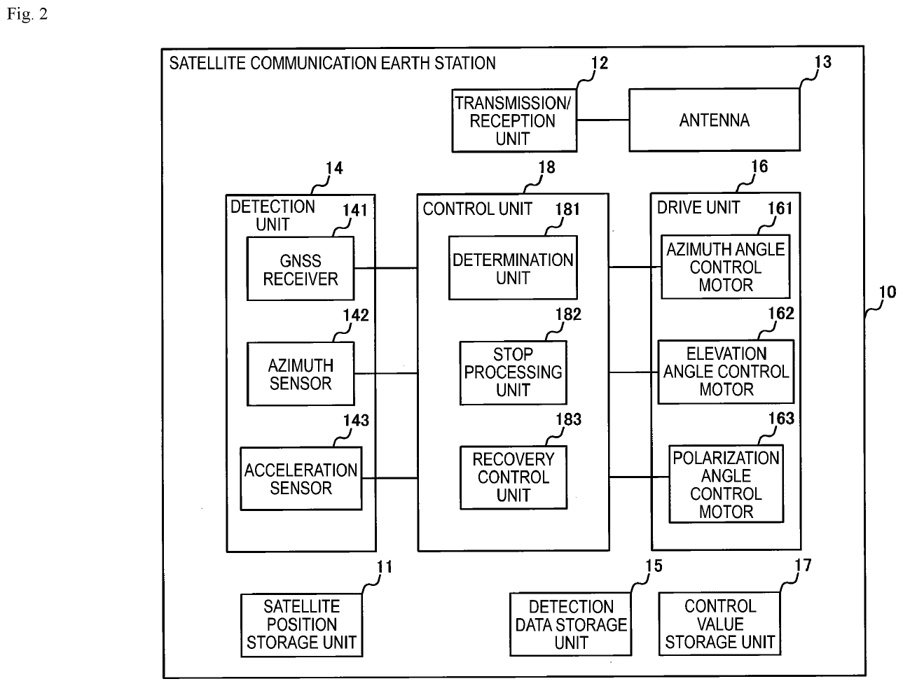

FIG. 2 is a functional block diagram illustrating, as an example, an overview of functions that each satellite communication earth station 10 has according to the embodiment. As illustrated in FIG. 2, the satellite communication earth station 10 includes a satellite position storage unit 11, a transmission/reception unit 12, an antenna 13, a detection unit 14, a detection data storage unit 15, a drive unit 16, a control value storage unit 17, and a control unit 18.

The satellite position storage unit 11 stores, for example, the position (the latitude, the longitude, and the altitude) of the communication satellite 20 (FIG. 1), which is a stationary satellite, in advance. Note that the communication satellite 20 is not limited to a stationary satellite and may be a moving satellite.

The transmission/reception unit 12 transmits and receives signals to and from the communication satellite 20 via the antenna 13. For example, the transmission/reception unit 12 modulates data transmitted from the satellite communication earth station 10 to the communication satellite 20 into a radio signal and outputs the radio signal to the antenna 13. Also, the transmission/reception unit 12 demodulates the radio signal received by the antenna 13 from the communication satellite 20.

Note that signals transmitted and received by the transmission/reception unit 12 include data (main signal) and control signals used to control line setting and the like among the plurality of satellite communication earth stations 10.

The antenna 13 is provided at an upper portion of the satellite communication earth station 10, for example, such that the azimuth angle, the elevation angle, and the polarization angle thereof become variable, and transmits and receives radio waves to and from the communication satellite 20.

The detection unit 14 includes, for example, a GNSS receiver 141, an azimuth sensor 142, and an acceleration (gravity) sensor 143.

The GNSS receiver 141 detects the latitude, the longitude, and the altitude of the antenna 13 or the satellite communication earth station 10 through reception of signals from navigation satellites, such as a GPS and a QZSS, for example, and outputs the detected latitude, the longitude, and the altitude to the control unit 18. The azimuth sensor 142 detects an azimuth in which the antenna 13 or the satellite communication earth station 10 is directed and outputs the detected azimuth to the control unit 18. The acceleration sensor 143 detects the inclination of the antenna 13 or the satellite communication earth station 10 with respect to an installation surface and outputs the detected inclination to the control unit 18.

Although it is assumed that the detection unit 14 detects each value regarding the antenna 13 here, the detection unit 14 may detect values regarding the satellite communication earth station 10 and regard the values substantially as values for the antenna 13 or may detect values that can be converted into values for the antenna 13.

Also, the detection unit 14 performs the detection at a predetermined cycle when the satellite communication earth station 10 performs communication with the communication satellite 20.

The detection data storage unit 15 stores the latitude, the longitude, the altitude, the azimuth, and the inclination detected by the detection unit 14. Note that because the detection unit 14 detects the latitude, the longitude, the altitude, the azimuth, and the inclination at the predetermined cycle when the satellite communication earth station 10 performs communication, the detection data storage unit 15 periodically stores each of the latitude, the longitude, the altitude, the azimuth, and the inclination detected by the detection unit 14. In addition, it is assumed that the detection data storage unit 15 stores a threshold value (which will be described later) of the amount of change for each detection result of the detection unit 14 in advance.

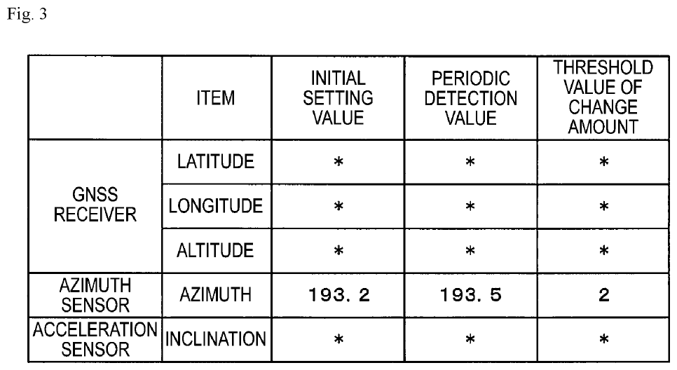

FIG. 3 is a diagram illustrating, as an example, each value stored in the detection data storage unit 15. The detection data storage unit 15 stores an initial setting value, a periodic detection value, and a change amount threshold value for each of the GNSS receiver 141, the azimuth sensor 142, and the acceleration sensor 143, for example.

The drive unit 16 includes an azimuth angle control motor 161, an elevation angle control motor 162, and a polarization angle control motor 163.

The azimuth angle control motor 161 drives the antenna 13 such that the azimuth (a rotation angle from the initial setting) in which the antenna 13 is directed is adjusted in accordance with the communication satellite 20 that is a target of communication in accordance with control performed by the control unit 18. The elevation angle control motor 162 drives the antenna 13 such that the elevation angle (a rotation angle from the initial setting) of the antenna 13 is adjusted in accordance with the communication satellite 20 that is a target of communication in accordance with control performed by the control unit 18. The polarization angle control motor 163 drives the antenna 13 such that the polarization angle (a rotation angle from the initial setting) of radio waves transmitted and received by the antenna 13 is adjusted in accordance with the communication satellite 20 that is a target of communication in accordance with control performed by the control unit 18.

For example, the drive unit 16 may perform the driving to adjust the direction of the antenna 13 based on the latitude, the longitude, the altitude, the azimuth, and the inclination detected by the detection unit 14. In other words, the drive unit 16 may drive (adjust) the antenna 13 at a predetermined cycle when the satellite communication earth station 10 performs communication with the communication satellite 20.

The control value storage unit 17 stores each control value (a rotation angle from the initial setting) indicating the amount by which the drive unit 16 has driven the antenna 13.

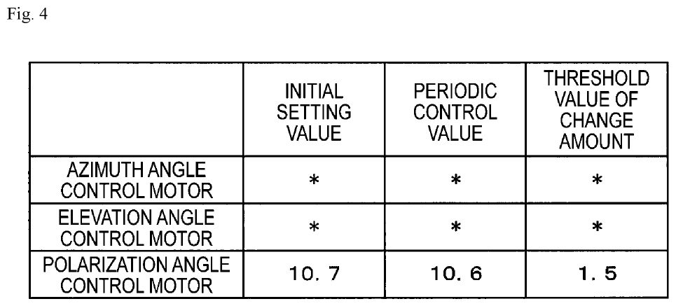

FIG. 4 is a diagram illustrating, as an example, each value stored in the control value storage unit 17. The control value storage unit 17 stores an initial setting value, a periodic detection value, and a change amount threshold value for each of the azimuth angle control motor 161, the elevation angle control motor 162, and the polarization angle control motor 163, for example.

The control unit 18 includes a determination unit 181, a stop processing unit 182, and a recovery control unit 183 and controls each component constituting the satellite communication earth station 10. Also, it is assumed that the control unit 18 has a function of calculating a direction directed from the antenna 13 to the communication satellite 20 based on the latitude, the longitude, the altitude, the azimuth, and the inclination of the antenna 13 (or the satellite communication earth station 10).

The determination unit 181 determines whether or not at least any of the longitude, the latitude, the altitude, the azimuth, or the inclination detected by the detection unit 14 or the azimuth angle, the elevation angle, or the polarization angle driven by the drive unit 16 has experienced a change that is equal to or greater than a predetermined threshold value from an initial setting value.

In a case in which the determination unit 181 determines that there has been a change that is equal to or greater than the predetermined threshold value from the initial setting value, the stop processing unit 182 stops the transmission of radio waves (the main signals and the control signals) from the antenna 13 (wave stop processing). Note that the stop processing unit 182 may cause the antenna 13 to stop the transmission of radio waves or may stop the transmission/reception unit 12 to stop the transmission. Moreover, the stop processing unit 182 may lower a transmission level such that no radio wave interferences are provided to other satellites by lowering a transmission power from the antenna 13 by 50 dB, for example, instead of performing the wave stop processing.

The recovery control unit 183 controls such that the drive unit 16 drives the antenna to adjust the azimuth angle, the elevation angle, and the polarization angle of the antenna 13 to the communication satellite 20 after elapse of a predetermined time after the stop processing unit 182 stops the transmission of radio waves from the antenna 13.

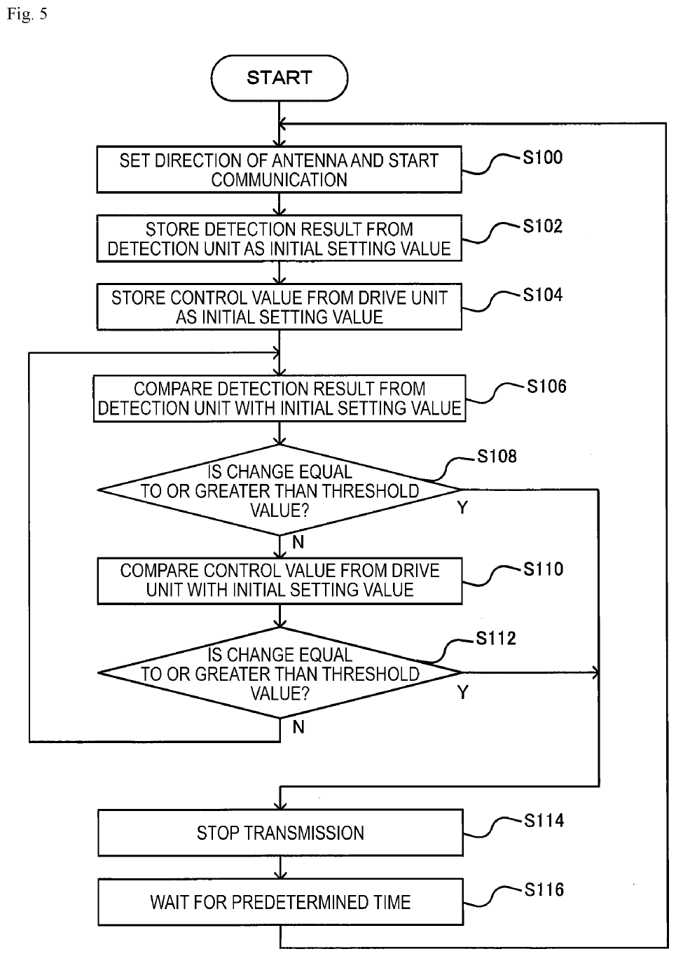

Next, an operation example of the satellite communication earth station 10 will be described. FIG. 5 is a flowchart illustrating an operation example of the satellite communication earth station 10 according to an embodiment.

When the satellite communication earth station 10 receives data from the connected communication device 30, for example, then the direction of the antenna 13 is set to be directed to the communication satellite 20 under control of the control unit 18, and communication with the communication satellite 20 is started (S100).

When the detection unit 14 detects the latitude, the longitude, and the altitude, the azimuth, and the inclination of the antenna 13 or the satellite communication earth station 10, then the detection data storage unit 15 stores each of the detection results of the detection unit 14 as an initial setting value (S102). For example, as illustrated as an example in FIG. 3, the detection data storage unit 15 stores the value “193.2” degrees as an initial setting value of the azimuth.

Also, if the drive unit 16 performs driving to direct the antenna 13 to the communication satellite 20, then the control value storage unit 17 stores each control value of the drive unit 16 as an initial setting value (S104).

Next, the determination unit 181 compares the periodic detection result of the detection unit 14 with the initial setting value (S106) and determines whether or not a change in the detection result with respect to the initial setting value is equal to or greater than a threshold value (S108). The determination unit 181 moves on to the processing in S114 in a case in which it is determined that the change is equal to or greater than the threshold value (S108: Yes), or the determination unit 181 moves on to the processing in S110 in a case in which it is determined that the change is not equal to or greater than the threshold value (S108: No).

In a case in which the initial setting value of the azimuth is “193.2” degrees, and the detection data storage unit 15 stores “2” as a change amount threshold value of the azimuth, and if the detection unit 14 detects a value “193.5” degrees as a detection value of the azimuth as illustrated in FIG. 3, for example, the determination unit 181 determines that the change is not equal to or greater than the threshold value.

Also, the determination unit 181 compares the periodic control value (adjustment value) of the drive unit 16 with the initial setting value (S110) and determines whether or not the change of the control value with respect to the initial setting value is equal to or greater than a threshold value (S112). The determination unit 181 moves on to the processing in S114 in a case in which it is determined that the change is equal to or greater than the threshold value (S112: Yes), or the determination unit 181 returns to the processing in S106 in a case in which it is determined that the change is not equal to or greater than the threshold value (S112: No).

In a case in which the initial setting value of the polarization angle is “10.7”, and the control value storage unit 17 stores “1.5” as a change amount threshold value of the polarization angle, and when the control value of the drive unit 16 in regard to the polarization angle is “10.6” as illustrated in FIG. 4, for example, the determination unit 181 determines that the change is not equal to or greater than the threshold value.

In the processing in S114, the stop processing unit 182 causes the transmission of radio waves (the main signals and the control signals) from the antenna 13 to be stopped.

Then, the recovery control unit 183 waits for a predetermined time (10 seconds, for example) in a state in which the transmission of radio waves from the antenna 13 is stopped (S116) and then returns to the processing in S110.

In this manner, because the stop processing unit 182 stops the transmission of radio waves from the antenna 13 in a case where the determination unit 181 determines that a change from the initial setting value to the predetermined threshold value or more is made, the satellite communication earth station 10 can prevent radio wave interference from being given to other satellites when the direction of the antenna 13 changes due to disturbance.

Also, the satellite communication earth station 10 may be configured to include a camera sensor for capturing surroundings images, detect the amount of change in the images, and perform wave stop processing. In this case, the satellite communication earth station 10 may ignore some of changes in the images such as crossing of a person or a car, for example, in an image and detect changes in the images such as a change in background due to falling over of the host satellite communication earth station 10.

Also, the satellite communication earth station 10 may be configured to include a distance sensor, measure the distances to surrounding buildings at a predetermined cycle, detect the amounts of change in distances, and perform wave stop processing.

Moreover, the changes regarding the antenna 13 are not limited to those of detection inside the satellite communication earth station 10, and other devices mounted in the surroundings, a control center placed at a remote location, or the like may detect the changes. In this case, the changes detected by other devices or the control center are transmitted to the satellite communication earth station 10 via a communication line or the like, and the satellite communication earth station 10 performs wave stop processing.

Thus, the satellite communication system 1 can prevent the communication from being continued with a degraded communication quality due to a change in direction of the antenna 13 included in the satellite communication earth station 10.

Note that each function included in the satellite communication earth station 10, the communication satellite 20, and the communication device 30 may be partially or entirely configured with hardware or may be configured as a program to be executed by a processor such as a CPU.

In other words, the satellite communication system 1 according to the present disclosure can be achieved using a computer and the program, and it is possible to record the program in a storage medium or to provide the program through a network.

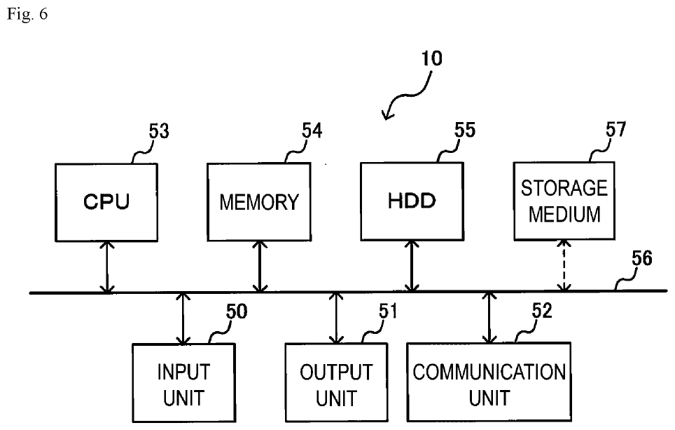

FIG. 6 is a diagram illustrating a hardware configuration example of the satellite communication earth station 10 according to the embodiment. As illustrated in FIG. 6, the satellite communication earth station 10 has functions of a computer with an input unit 50, an output unit 51, a communication unit 52, a CPU 53, a memory 54, and an HDD 55 connected via a bus 56, for example. Also, the satellite communication earth station 10 is adapted to be able to input and output data to and from the storage medium 57.

The input unit 50 is, for example, a keyboard, a mouse, and the like. The output unit 51 is, for example, a display device such as a display. The communication unit 52 is, for example, a wireless network interface.

The CPU 53 controls each component constituting the satellite communication earth station 10 and performs the aforementioned processing. The memory 54 and the HDD 55 store data. The storage medium 57 is adapted to be able to store a received program and the like that causes the functions included in the satellite communication earth station 10 to be executed. The architecture constituting the satellite communication earth station 10 is not limited to the example illustrated in FIG. 6. Also, the communication satellite 20 and the communication device 30 may also include configurations similar to that of the satellite communication earth station 10.

### REFERENCE SIGNS LIST

1 Satellite communication system
10 Satellite communication earth station
11 Satellite position storage unit
12 Transmission/reception unit
13 Antenna
14 Detection unit
15 Detection data storage unit
16 Drive unit
17 Control value storage unit
18 Control unit
20 Communication satellite
30 Communication device
50 Input unit
51 Output unit
52 Communication unit
53 CPU
54 Memory
55 HDD
56 Bus
57 Storage medium
141 GNSS receiver
142 Azimuth sensor
143 Acceleration sensor
161 Azimuth angle control motor
162 Elevation angle control motor
163 Polarization angle control motor
181 Determination unit
182 Stop processing unit
183 Recovery control unit

1. A satellite communication earth station for adjusting an azimuth angle, an elevation angle, and a polarization angle of an antenna to a communication satellite and then transmitting and receiving a radio wave between the antenna and the communication satellite, the satellite communication earth station comprising:
a detection unit configured to detect a longitude, a latitude, an altitude, an azimuth, and an inclination of the antenna;
a drive unit configured to drive the antenna to adjust the azimuth angle, the elevation angle, and the polarization angle of the antenna to the communication satellite;
a determination unit configured to determine whether the longitude, the latitude, the altitude, the azimuth, or the inclination detected by the detection unit or the azimuth angle, the elevation angle, or the polarization angle driven by the drive unit makes a change from an initial setting value to a predetermined threshold values or more; and
a stop processing unit configured to stop transmission of the radio wave from the antenna when the determination unit determines that the change from the initial setting value to the predetermined threshold value or more is made.

2. The satellite communication earth station according to claim 1, further comprising
a recovery control unit configured to control such that the drive unit drives the antenna to adjust the azimuth angle, the elevation angle, and the polarization angle of the antenna to the communication satellite after elapse of a predetermined time after the stop processing unit stops the transmission of the radio wave from the antenna.

3. A communication control method for controlling communication of a satellite communication earth station for adjusting an azimuth angle, an elevation angle, and a polarization angle of an antenna to a communication satellite and then transmitting and receiving a radio wave between the antenna and the communication satellite, the method comprising:
detecting a longitude, a latitude, an altitude, an azimuth, and an inclination of the antenna;
driving the antenna to adjust the azimuth angle, the elevation angle, and the polarization angle of the antenna to the communication satellite;
determining whether the longitude, the latitude, the altitude, the azimuth, or the inclination detected or the azimuth angle, the elevation angle, or the polarization angle driven makes a change from an initial setting value to a predetermined threshold value or more; and
stopping transmission of the radio wave from the antenna when it is determined that the change from the initial setting value to the predetermined threshold value or more is made.

4. The communication control method according to claim 3, further comprising
controlling to drive the antenna to adjust the azimuth angle, the elevation angle, and the polarization angle of the antenna to the communication satellite after elapse of a predetermined time after the transmission of the radio wave from the antenna is stopped.
